(19) United States
(12) Patent Application Publication
(10) Pub. No.: US 2026/0197782 A1
(43) Pub. Date: Jul. 9, 2026

(54) DATA TRANSMISSION SYSTEM AND DATA TRANSMISSION METHOD

(71) Applicant: REALTEK SEMICONDUCTOR CORPORATION, Hsinchu (TW)

(72) Inventors: Shan-Yuan YANG, Hsinchu (TW); Po-Hsien WU, Hsinchu (TW); Huan-Wen CHEN, Hsinchu (TW)

(21) Appl. No.: 19/431,477

(22) Filed: Dec. 23, 2025

(30) Foreign Application Priority Data
Jan. 9, 2025 (TW) 114100989

(51) Int. Cl. H04W 56/00; H04L 1/00

(52) U.S. Cl. CPC H04W 56/0015; H04L 1/0067

(57) ABSTRACT

A data transmission system includes a transmitter and a receiver. The transmitter receives an image data of a signal source at a first time, generate a transmitter signal event according to a transmitter timing information, and transmit the transmitter signal event and the image data through a network. The receiver receives the transmitter signal event and the image data through the network, and obtain the transmitter timing information according to the transmitter signal event. The receiver adjusts a receiver data transmission speed of the receiver according to the transmitter timing information, so that a transmitter data transmission speed of the transmitter and the receiver data transmission speed of the receiver are consistent. The receiver transmits the image data at a second time, and a time difference between the first time and the second time is smaller than three frames of the image data.

### BACKGROUND OF THE INVENTION

### 1. Field of the Invention

The present disclosure relates to a data transmission system and a data transmission method, especially to a data transmission system and a data transmission method that can ensure consistency between transmission speeds of a transmitter and a receiver.

### 2. Description of Related Art

In a data transmission system, a transmitter is configured to output data, and a receiver receives the aforementioned data to complete the transmission of data. In order to perform data transmission between integrated circuits (ICs), the data is generally transmitted in a non-network manner. For example, if the data is transmitted between the integrated circuits through non-network wires, the length of the non-network wires will limit the placement space of the integrated circuits.

### SUMMARY OF THE INVENTION

In some aspects, an object of the present disclosure is to, but not limited to, provides a data transmission system and a data transmission method that makes an improvement to the prior art.

An embodiment of a data transmission system of the present disclosure includes a transmitter and a receiver. The transmitter is configured to receive at least one image data of a signal source at a first time, generate at least one transmitter signal event according to a transmitter timing information, and transmit the at least one transmitter signal event and the at least one image data through a network. The receiver is configured to receive the at least one transmitter signal event and the at least one image data through the network, and obtain the transmitter timing information according to the at least one transmitter signal event, wherein the receiver is configured to adjust a receiver data transmission speed of the receiver according to the transmitter timing information, so that a transmitter data transmission speed of the transmitter and the receiver data transmission speed of the receiver are consistent. The receiver transmits the at least one image data at a second time, and a time difference between the first time and the second time is smaller than three frames of the at least one image data.

An embodiment of a data transmission method of the present disclosure includes: receiving at least one image data of a signal source at a first time, generating at least one transmitter signal event according to a transmitter timing information, and transmitting the at least one transmitter signal event and the at least one image data through a network by a transmitter; receiving the at least one transmitter signal event and the at least one image data through the network, and obtaining the transmitter timing information according to the at least one transmitter signal event by a receiver; and adjusting a receiver data transmission speed of the receiver according to the transmitter timing information by the receiver, so that a transmitter data transmission speed of the transmitter and the receiver data transmission speed of the receiver are consistent, wherein the receiver transmits the at least one image data at a second time, and a time difference between the first time and the second time is smaller than three frames of the at least one image data.

Technical features of some embodiments of the present disclosure make an improvement to the prior art. The data transmission system and the data transmission method of the present disclosure can transmit data through a network, thereby avoiding the limitation of the placement space of integrated circuits (ICs) caused by the length of non-network wires when data is transmitted through the non-network wires. In addition, the data transmission system and the data transmission method of the present disclosure can adjust the data transmission speed of the receiver, so that the data transmission speed (throughput) of the transmission port (TX) of the receiver can track the data transmission speed (throughput) of the transmission port (TX) of the transmitter, thereby achieving the goal of consistency between the data transmission speeds of the transmitter and the receiver.

These and other objectives of the present invention will no doubt become obvious to those of ordinary skill in the art after reading the following detailed description of the preferred embodiments that are illustrated in the various figures and drawings.

### BRIEF DESCRIPTION OF THE DRAWINGS

FIG. 1 shows an embodiment of a data transmission system of the present disclosure.

FIG. 2 shows an embodiment of a flow diagram of a data transmission method of the present disclosure.

FIG. 3 shows an embodiment of an operation diagram of a data transmission system of the present disclosure.

### DETAILED DESCRIPTION OF THE PREFERRED EMBODIMENTS

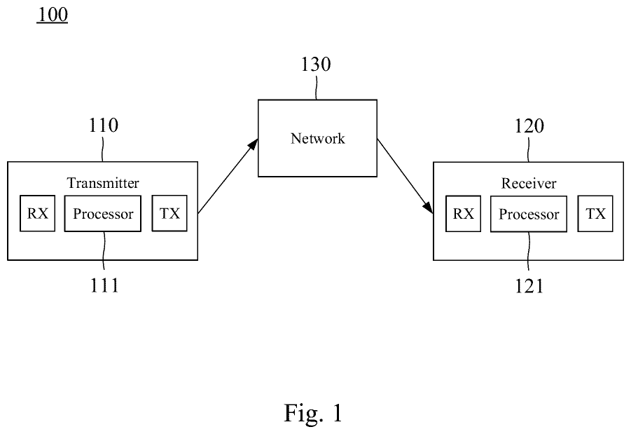

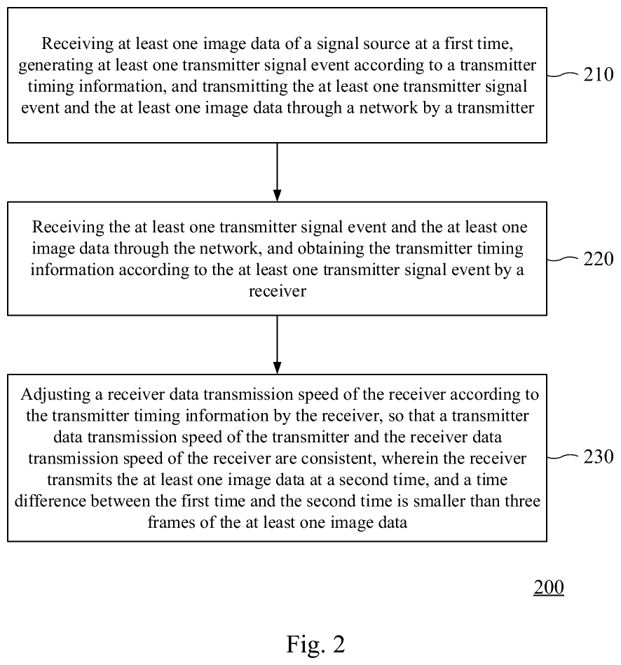

FIG. 1 shows an embodiment of a data transmission system 100 of the present disclosure. As shown in the figure, the data transmission system 100 includes a transmitter 110 and a receiver 120. The transmitter 110 includes a processor 111, and the receiver 120 includes a processor 121. Both the transmitter 110 and the receiver 120 includes a receiving port RX and a transmitting port TX. To facilitate understanding of the operation of the data transmission system 100, please also refer to FIG. 2. FIG. 2 shows an embodiment of a flow diagram of a data transmission method 200 of the present disclosure.

Referring to step 210 in FIG. 2, receiving at least one image data of a signal source at a first time, generating at least one transmitter signal event according to a transmitter timing information, and transmitting the at least one transmitter signal event and the at least one image data through a network by a transmitter. For example, referring to FIG. 1, the processor 111 of the transmitter 110 may receive image data of a signal source RX at the first time. The processor 111 of the transmitter 110 may convert transmitter timing information into a transmitter signal event, and transmit the transmitter signal event and the image data to the receiver 120 through a network 130. It should be noted that the network transmission (e.g., the network 130) includes a wired network (e.g., Ethernet) and a wireless network (e.g., Wi-Fi). Regardless of whether a wired or wireless network is adopted, both fall within the protection scope of the present disclosure. In some embodiments, the data transmission system 100 and the data transmission method 200 of the present disclosure are applicable to a signal source RX having a frame rate equal to or greater than 10 Hz (including 10 Hz).

Referring to step 220 in FIG. 2, receiving the at least one transmitter signal event and the at least one image data through the network, and obtaining the transmitter timing information according to the at least one transmitter signal event by a receiver. For example, referring to FIG. 1, the processor 121 of the receiver 120 may receive the transmitter signal event and the image data from the network 130, and derive the transmitter timing information from the transmitter signal event.

Referring to step 230 in FIG. 2, adjusting a receiver data transmission speed of the receiver according to the transmitter timing information by the receiver, so that a transmitter data transmission speed of the transmitter and the receiver data transmission speed of the receiver are consistent, wherein the receiver transmits the at least one image data at a second time, and a time difference between the first time and the second time is smaller than three frames of the at least one image data. For example, referring to FIG. 1, the receiver 120 may track the transmitter timing information to adjust a receiver data transmission speed (throughput) of the receiver 120, so that a transmitter data transmission speed (throughput) of a transmitting port TX of the transmitter 110 and a receiver data transmission speed (throughput) of a transmitting port TX of the receiver 120 are consistent. The receiver 120 may transmit the image data at the second time, and the time difference between the first time and the second time is smaller than three frames of the image data. For example, the aforementioned time difference is a phase difference time between the transmitter 110 receiving image data of the signal source RX and the receiver 120 transmitting the image data. The overall path includes the transmitter 110 receiving the image data of the signal source RX, the transmitter 110 converting the image data into packages, the packages being transmitted through the network 130, the receiver 120 receiving the packages, the receiver 120 converting the packages, and the receiver 120 transmitting the image data. The aforementioned frame is defined according to the frame rate of the signal source RX. For example, if the signal source RX operates at 60 Hz, three frames correspond to a delay of three 60 Hz frames, which is equal to

$$\frac{3 s}{60 Hz} ,$$

i.e., 50 milliseconds (ms). Accordingly, the data transmission system 100 and the data transmission method 200 of the present disclosure exhibit a low latency characteristic. Compared with the longer delay in the prior art, the low latency of the present disclosure can be at a line level latency.

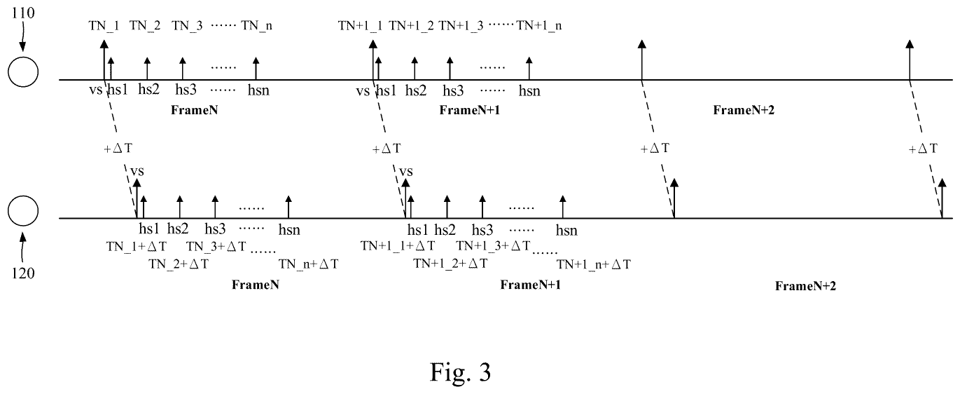

FIG. 3 shows an embodiment of an operation diagram of a data transmission system 100 of the present disclosure. Referring to FIG. 1 and FIG. 3, the transmitter 110 may generate a plurality of transmitter signal events vs, hs1~hsn according to transmitter timing information. In addition, the transmitter 110 may mark a plurality of timestamps TN_1~TN_n on the plurality of transmitter signal events vs, hs1~hsn. Subsequently, the transmitter 110 may generate a plurality of packages according to the plurality of transmitter signal events vs, hs1~hsn, and transmit the plurality of packages and the at least one image data to the receiver 120 through the network 130.

In some embodiments, referring to FIG. 1 and FIG. 3, the receiver 120 may receive a plurality of packages and at least one image data through the network 130, and recover a plurality of transmitter signal events vs, hs1~hsn according to a plurality of timestamps TN_1~TN_n in the plurality of packages and a package transmission delay ΔT.

In some embodiments, referring to FIG. 1 and FIG. 3, the receiver 120 may adjust a receiver data transmission speed (throughput) of the receiver 120 according to a plurality of transmitter signal events vs, hs1~hsn of the transmitter 110 and a plurality of receiver events of the receiver 120 itself, so that a transmitter data transmission speed (throughput) of a transmitting port TX of the transmitter 110 and a receiver data transmission speed (throughput) of a transmitting port TX of the receiver 120 are consistent. Specifically, the receiver 120 may compare the plurality of transmitter signal events vs, hs1~hsn of the transmitter 110 and the plurality of receiver events of the receiver 120 itself to obtain a phase difference between them, and adjust the receiver data transmission speed (throughput) of the receiver 120 according to the phase difference, so that the transmitter data transmission speed (throughput) of the transmitting port TX of the transmitter 110 and the receiver data transmission speed (throughput) of the transmitting port TX of the receiver 120 are consistent.

In some embodiments, referring to FIG. 1 and FIG. 3, a transmitter time of the transmitter 110 is synchronized with a receiver time of the receiver 120. For example, the transmitter 110 and the receiver 120 may be calibrated by a world clock, so that the transmitter time of the transmitter 110 is synchronized with the receiver time of the receiver 120, thereby enabling the transmitter 110 and the receiver 120 of the data transmission system 100 to operate based on the same time reference.

It should be noted that the present disclosure is not limited to the embodiments as shown in FIG. 1 to FIG. 3, they are merely examples for illustrating the implements of the present disclosure, and the scope of the present disclosure shall be defined based on the claims as shown below. In view of the foregoing, it is intended that the present disclosure covers modifications and variations to the embodiments of the present disclosure, and modifications and variations to the embodiments of the present disclosure also fall within the scope of the following claims and their equivalents.

As described above, technical features of some embodiments of the present disclosure make an improvement to the prior art. The data transmission system 100 and the data transmission method 200 of the present disclosure can transmit data through the network 130, thereby avoiding the limitation of the placement space of integrated circuits (ICs) caused by the length of non-network wires when data is transmitted through the non-network wires. In addition, the data transmission system 100 and the data transmission method 200 of the present disclosure can adjust the data transmission speed of the receiver 120, so that the data transmission speed (throughput) of the transmission port (TX) of the receiver 120 can track the data transmission speed (throughput) of the transmission port (TX) of the transmitter 110, thereby achieving the goal of consistency between the data transmission speeds of the transmitter 110 and the receiver 120. Furthermore, the data transmission system 100 and the data transmission method 200 of the present disclosure exhibit a low latency characteristic. Compared with the longer delay in the prior art, the low latency of the present disclosure can be at a line level latency.

It is noted that people having ordinary skill in the art can selectively use some or all of the features of any embodiment in this specification or selectively use some or all of the features of multiple embodiments in this specification to implement the present invention as long as such implementation is practicable; in other words, the way to implement the present invention can be flexible based on the present disclosure.

The descriptions represent merely the preferred embodiments of the present invention, without any intention to limit the scope of the present invention thereto. Various equivalent changes, alterations, or modifications based on the claims of the present invention are all consequently viewed as being embraced by the scope of the present invention.

What is claimed is:

1. A data transmission system, comprising:
a transmitter, configured to receive at least one image data of a signal source at a first time, generate at least one transmitter signal event according to a transmitter timing information, and transmit the at least one transmitter signal event and the at least one image data through a network; and
a receiver, configured to receive the at least one transmitter signal event and the at least one image data through the network, and obtain the transmitter timing information according to the at least one transmitter signal event, wherein the receiver is configured to adjust a receiver data transmission speed of the receiver according to the transmitter timing information, so that a transmitter data transmission speed of the transmitter and the receiver data transmission speed of the receiver are consistent;
wherein the receiver transmits the at least one image data at a second time, and a time difference between the first time and the second time is smaller than three frames of the at least one image data.

2. The data transmission system of claim 1, wherein the transmitter is further configured to generate a plurality of transmitter signal events according to the transmitter timing information, wherein the transmitter is further configured to mark a plurality of timestamps on the plurality of transmitter signal events, generate a plurality of packages according to the plurality of transmitter signal events, and transmit the plurality of packages and the at least one image data through the network.

3. The data transmission system of claim 2, wherein the receiver is further configured to receive the plurality of packages and the at least one image data through the network, and restore the plurality of transmitter signal events according to the plurality of timestamps in the plurality of packages and a package transmission delay.

4. The data transmission system of claim 3, wherein the receiver is further configured to adjust the receiver data transmission speed of the receiver according to the plurality of transmitter signal events of the transmitter and a plurality of receiver events of the receiver, so that the transmitter data transmission speed of the transmitter and the receiver data transmission speed of the receiver are consistent.

5. The data transmission system of claim 4, wherein the receiver is further configured to compare the plurality of transmitter signal events of the transmitter and the plurality of receiver events of the receiver to obtain a phase difference, and adjust the receiver data transmission speed of the receiver according to the phase difference, so that the transmitter data transmission speed of the transmitter and the receiver data transmission speed of the receiver are consistent.

6. A data transmission method, comprising:
receiving at least one image data of a signal source at a first time, generating at least one transmitter signal event according to a transmitter timing information, and transmitting the at least one transmitter signal event and the at least one image data through a network by a transmitter;
receiving the at least one transmitter signal event and the at least one image data through the network, and obtaining the transmitter timing information according to the at least one transmitter signal event by a receiver; and
adjusting a receiver data transmission speed of the receiver according to the transmitter timing information by the receiver, so that a transmitter data transmission speed of the transmitter and the receiver data transmission speed of the receiver are consistent, wherein the receiver transmits the at least one image data at a second time, and a time difference between the first time and the second time is smaller than three frames of the at least one image data.

7. The data transmission method of claim 6, wherein generating the at least one transmitter signal event according to the transmitter timing information, and transmitting the at least one transmitter signal event and the at least one image data through the network by the transmitter comprises:
generating a plurality of transmitter signal events according to the transmitter timing information by the transmitter;
marking a plurality of timestamps on the plurality of transmitter signal events by the transmitter; and
generating a plurality of packages according to the plurality of transmitter signal events, and transmitting the plurality of packages and the at least one image data through the network by the transmitter.

8. The data transmission method of claim 7, wherein receiving the at least one transmitter signal event and the at least one image data through the network, and obtaining the transmitter timing information according to the at least one transmitter signal event by the receiver comprises:
receiving the plurality of packages and the at least one image data through the network, and restoring the plurality of transmitter signal events according to the plurality of timestamps of the plurality of packages and a package transmission delay by the receiver.

9. The data transmission method of claim 8, wherein adjusting the receiver data transmission speed of the receiver according to the transmitter timing information by the receiver, so that the transmitter data transmission speed of the transmitter and the receiver data transmission speed of the receiver are consistent comprises:
adjusting the receiver data transmission speed of the receiver according to the plurality of transmitter signal events of the transmitter and a plurality of receiver events of the receiver by the receiver, so that the transmitter data transmission speed of the transmitter and the receiver data transmission speed of the receiver are consistent.

10. The data transmission method of claim 9, wherein adjusting the receiver data transmission speed of the receiver according to the plurality of transmitter signal events of the transmitter and the plurality of receiver events of the receiver by the receiver, so that the transmitter data transmission speed of the transmitter and the receiver data transmission speed of the receiver are consistent comprises:
comparing the plurality of transmitter signal events of the transmitter and the plurality of receiver events of the receiver to obtain a phase difference, and adjusting the receiver data transmission speed of the receiver according to the phase difference by the receiver, so that the transmitter data transmission speed of the transmitter and the receiver data transmission speed of the receiver are consistent.
